(19) United States
(12) Patent Application Publication
(10) Pub. No.: US 2015/0012369 A1
(43) Pub. Date: Jan. 8, 2015

(54) METHOD AND APPARATUS FOR DISPLAYING ADVERTISEMENTS WITH MULTIPLE CREATIVES IN A PREDEFINED SEQUENCE

(71) Applicant: GoldSpot Media, Inc., Sunnyvale, CA (US)

(72) Inventors: Srini DHARMAJI, Cupertino, CA (US); Pawel S. VESELOV, Saratoga, CA (US)

(21) Appl. No.: 13/935,268

(22) Filed: Jul. 3, 2013

(51) Int. Cl. G06Q 30/02

(52) U.S. Cl. CPC G06Q 30/0277
USPC 705/14.73

(57) ABSTRACT

A method and system are provided for displaying on internet connected display-devices large advertisements having multiple sequential creatives belonging to an advertisement campaign. Examples of internet connected display-devices include; wireless enabled smart-phones; internet enabled phablets and tablets; personal-computer; laptops; note-books and smart-TVs. Since one or more of these devices can be owned by a single user and used at different times, the ads can be displayed only during the period when a particular device is switched on and content is being viewed on that particular device by a user. This makes tracking of creatives of large-advertisements belonging to a brand and a campaign requiring sequential viewing on a specific ICDD difficult. Thus a method is provided using the processing power and storage capability of the ICDD, with an installed micro-splicer, for sequencing of creatives and monitoring of the display for completion.

### BACKGROUND OF THE INVENTION

1. Technical Field

The invention relates to presenting large advertisements on internet connected display-devices, hereafter ICDDs, and specifically to displaying large advertisements with multiple creatives in a preferred order to achieve maximum impact of the advertisement campaign. Each creative is a small ad display that conveys a message or part of a message. Each large advertisement is an advertisement that contains multiple creatives that when presented in a predefined sequence convey a cohesive message to the viewer.

2. Description of the Background Art

Advertisements with multiple creatives are being generated and used during ad campaigns by advertisers. FIG. 1 is a simplified block diagram of ad delivery to a user of an ICDD 110. The ads 101 and 102 are a subset of two user specific short ads from a large group of ads specific for the user of the ICDD 110. The ads 101 and 102 each comprise at least one creative 305 and 306. The ads 101 and 102 are of a duration that can be displayed within a single ad spot within a streaming content 125. In most cases these user specific short ads are downloaded, typically over a wireless connection 120 or other available download means, via a communication input 111 on the ICDD 110. The ads 101 and 102 along with metadata relating to the ad and insertion specifications are downloaded and stored in a specific ad storage segment of the memory 112 on the ICDD 110. The prior art process for storing and displaying the short ads 101 and 102 have been described in further detail in the co-pending application Ser. No. 11/828,204 filed on Jul. 27, 2007 and the continuation application Ser. No. 12/881,011 filed on Sep. 13, 2010 by the same inventor and assigned to the same entity, which are incorporated into this application in their entirety by reference. When content 125 is being streamed over a wireless network 120 and is being viewed by the user of the ICDD 110, the ads 101 or 102 are selected from the group of stored ads in the memory 112 of the ICDD 110 based on the instructions contained in the metadata, also stored in the memory 112 on the ICDD. The selected ads 101 and 102 are inserted into the appropriately identified ad spots as per the instructions contained within the metadata. FIG. 2 shows an exemplary pattern 200, of insertion of selected ads 101 and 102 to be displayed on the display screen 114 of the ICDD 110 within the ad spots 205-1 through 205-6 within a content stream, wherein there is at least one ad to an ad-spot. The ad insertion is handled by the micro-splicer 115 installed on the ICDD 110 which is able to switch the display from a streaming content display buffer region of the memory to a selected ad storage buffer region of the memory, based on metadata. The micro-splicer 115 uses the processing power of the central processing unit 113 on the ICDD 110 to help organize the display of the correct ad on the display screen 114 of the ICDD 110.

Today large advertisements with multiple creatives are being generated and used during ad campaigns by advertisers. At the same time ICDDs, such as mobile handheld display devices, hereafter MHDDs, have become a main access for displaying ads to users. The ICDDs are individual communication devices and can be accessed for ad display only during the period when the user is viewing content. FIG. 3 shows an exemplary pattern of displaying ads 101 and 102 on an ICDD 110 when viewing content on the ICDD 110, where the ICDD 110 is being enabled intermittently. The intermittent nature of the viewing of content on the ICDD is shown by multiple breaks 501, 502 and 503 in the content stream. Since it is possible to display each of the ads 101 and 102 within a single ad-spot in the content stream the ads will be complete if the ICDD 110 is on during the ad-spot time as shown at the first ad-spot 205-1. If an ad is left incomplete within an ad-spot as shown at the second ad-spot 205-2 due to a break 502 in viewing of content, the message of the next ad in the next ad-spot 205-3 will not be impacted since each ad 101 and 102 is a complete ad. This is not the case where large ads with multiple creatives are concerned. The displaying of multiple creatives of an ad as a cohesive message on an ICDD 110 is difficult as current input into each ad-spot for display is handled as individual ads and differentiating between ads and creatives is difficult. Displaying of multiple creatives in sequence is made difficult due to the random nature of individual ICDD usage by the user when viewing a content stream. This randomness of usage of an ICDD results in the inability to provide the creatives of an ad, to the user, in a sequential order or in an order based on customer preference and demographics for maximum impact.

It would therefore be advantageous to provide a method and an apparatus for displaying multiple creatives of an ad in a preferred sequence on an ICDD. It would be further advantageous to change the order of display of the creatives based on user preference and the frequency of display in order to achieve maximum impact of the ad.

### SUMMARY OF THE INVENTION

A method and system are provided for displaying on internet connected display-devices large advertisements having multiple sequential creatives belonging to an advertisement campaign. Examples of internet connected display-devices include; wireless enabled smart-phones; internet enabled phablets and tablets; personal-computer; laptops; note-books and smart-TVs. Since one or more of these devices can be owned by a single user and used at different times, the ads can be displayed only during the period when a particular device is switched on and content is being viewed on that particular device by a user. This makes tracking of creatives of large-advertisements belonging to a brand and a campaign requiring sequential viewing on a specific ICDD difficult. Thus a method is provided using the processing power and storage capability of the ICDD, with an installed micro-splicer, for sequencing of creatives and monitoring of the display for completion.

Today large advertisements with multiple creatives, that need to be displayed in specific sequence, are being generated and used during ad campaigns by advertisers. The large advertisement comprising the client's message has multiple creatives, and in many advertisements the creatives convey the impact of the message of the client by having a predefined sequential order to be displayed. ICDDs are now a main vehicle for displaying ads to users. The ICDDs are individual communication devices specific to a user and can provide the capability for delivery of focused ads to individual users. A feature of the ICDD, due to it being a personally controlled multimedia device, is that it is not always available for ad display. For example, ICDDs may be in off states or may be used by the user in a use mode not compatible with ad display.

### BRIEF DESCRIPTION OF THE DRAWINGS

FIG. 1 is an exemplary block diagram of ad delivery to a user of a wireless enabled ICDD;

FIG. 2 is an exemplary block diagram of insertion of the selected ads to be displayed on an ICDD within the ad spots in a content stream;

FIG. 3 is an exemplary block diagram of insertion of the selected ads to be displayed on the ICDD, within the ad spots in the content stream when the ICDD is used intermittently;

FIG. 4 is an exemplary block diagram of a large advertisement with multi-creative provisioning and display system;

FIG. 5 is an exemplary block diagram of large advertisement delivery to a user of a wireless enabled ICDD;

FIG. 6 is an exemplary block diagram of insertion of selected large ads with multiple creatives to be displayed on the ICDD, within the ad spots in the content stream;

FIG. 7 is an exemplary block diagram of insertion of selected large advertisements with multiple creatives to be displayed on the ICDD, within ad-spots in the content stream when the ICDD is used intermittently;

FIG. 8 is an exemplary flow chart of the display of the large advertisements with multiple creatives providing complete message capability by eliminating partial display of creatives; and

FIG. 9 is a block schematic diagram that depicts a machine in the exemplary form of a computer system.

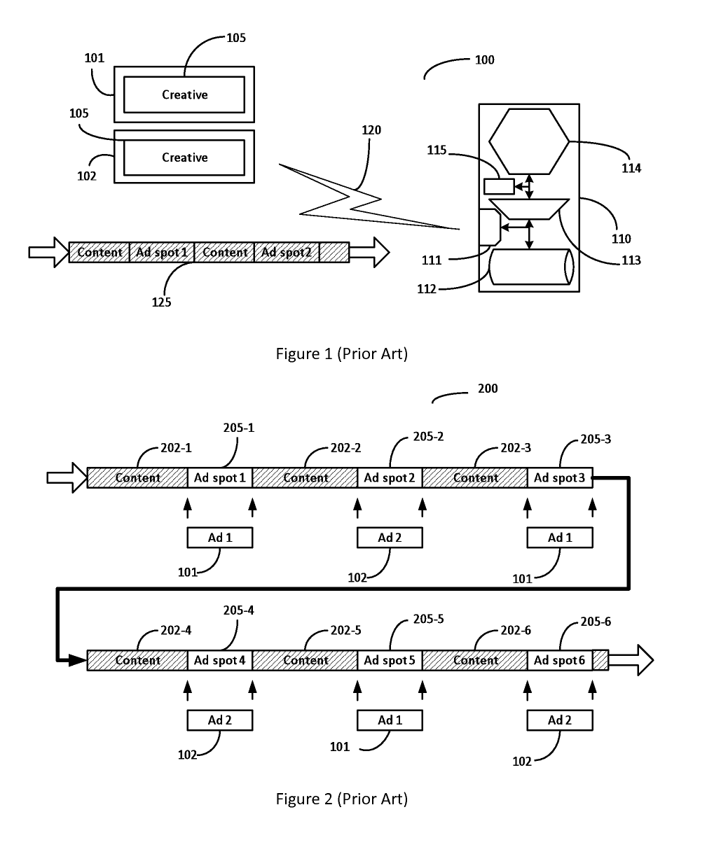

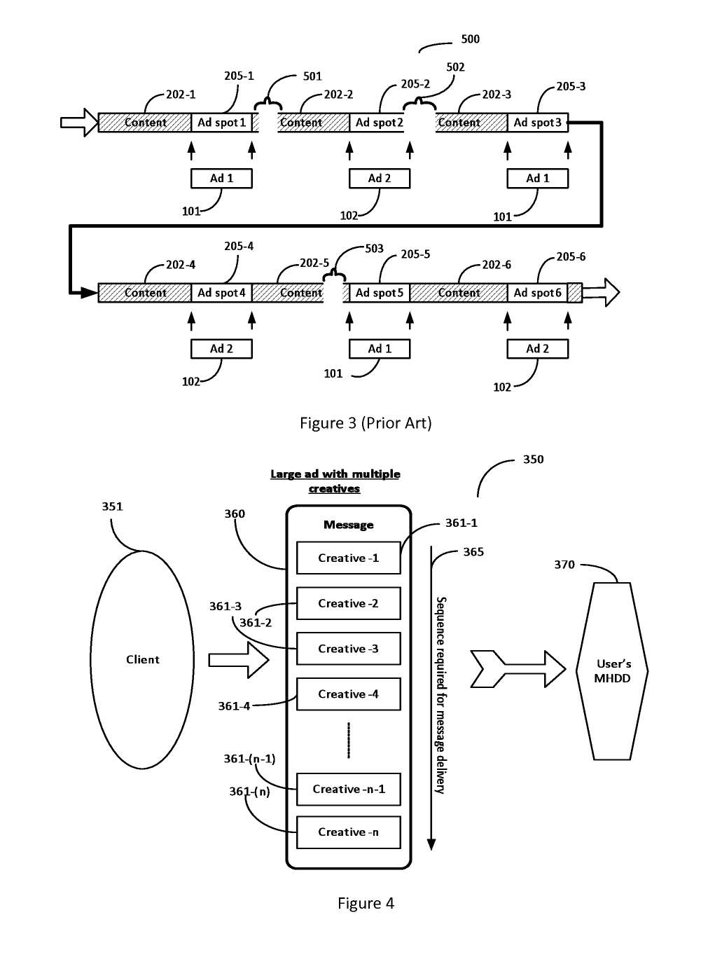

### DETAILED DESCRIPTION OF THE INVENTION

In an embodiment shown in FIG. 4 a large advertisement 360 is comprised of multiple creatives 361-1 to 361-n, where ‘n’ is the number of creatives generated by the client 351 for an ad campaign. The ad is provided to a digital ad service to be run during an ad campaign. The message of the ad campaign is best presented by showing the multiple creatives in a predefined sequential order 365 that is defined by the digital ad service responsible for running the ad campaign for the client 351 and ensuring the presentation of the ad to the user 370 on the user's ICDD. In an embodiment the creatives are presented to the user 370 in the predefined sequential order 365 on the user's ICDD during content viewing to achieve the full impact of the ad 360.

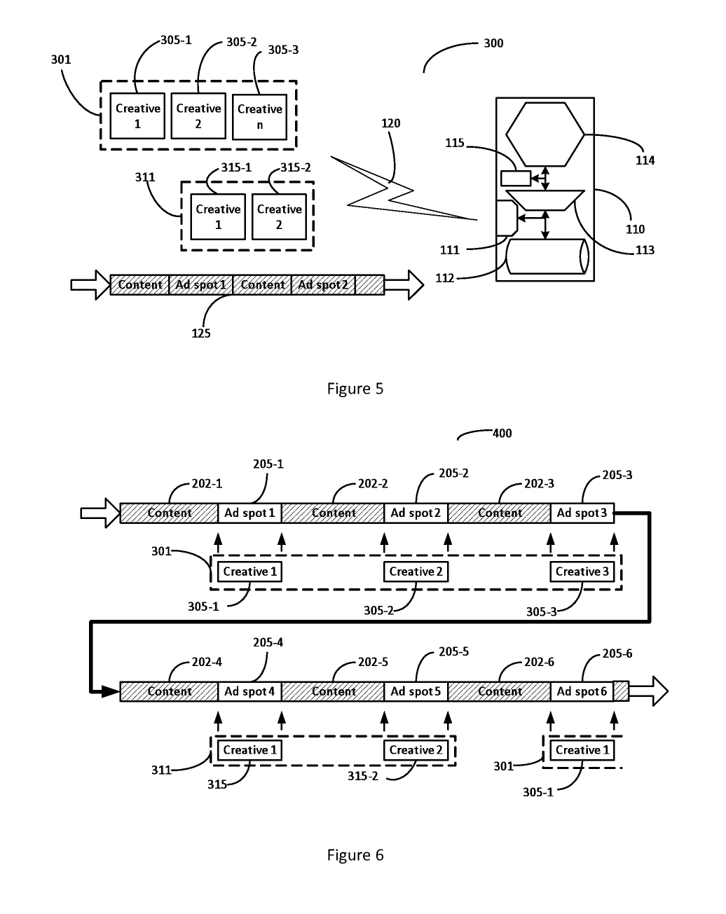

FIG. 5 is a block diagram 300 of an embodiment involving the delivery of a first large advertisement 301 with multiple creatives 305-1, 305-2 and 305-3; and delivery of a second large advertisement 311 with multiple creatives 315-1 and 315-2, to a user of a ICDD 110. These advertisements 301 and 311 are pre-delivered and stored in an alternate content storage location of the memory 112 of the ICDD 110. The information regarding the ads 301 and 311, including display requirements including the predefined sequence for the creatives within the ad to be displayed are also delivered to the ICDD in the form of metadata and stored in the memory 112 of the ICDD 110 with the ads 301 and 311. The advertisements, though large with multiple creatives are considered a single advertisement.

FIG. 6 shows a block diagram 400 of an embodiment displaying creatives 305-1 305-2 and 305-3, of a first advertisement 301, and creatives 315-1 and 315-2, of a second advertisement 311, on an ICDD 110 to a user when a user is viewing content 125 on the ICDD 110. In embodiments, content 125 is delivered to the ICDD, via wireless 120 connections to a communication module 111 on the ICDD, and is downloaded into a content display buffer which is part of the memory 112 on the ICDD 110. The micro-splicer enables content in the content display buffer to be displayed on the display 114 of the ICDD 110 by connecting the content display buffer to the display module associated with the display 114. During the display of the content 125 the micro-splicer 115 determines an appropriate first advertisement 301 to be displayed based on the type of content being displayed and the metadata associated with the advertisements 301 and 311, which contains instructions and information regarding the advertisements. Once the first advertisement 301 is determined, the first creative 305-1 in the predefined sequence of creatives of the first advertisement 301 is downloaded into an alternate content display buffer location in the memory 112 on the ICDD. In the embodiment shown in FIG. 6 when the first ad spot 205-1 is identified within the content stream, the micro-splicer 115 diverts the input of the display module associated with the display 114 on the ICDD 110 to display the content in the alternate content display buffer, rather than the content display buffer. This causes the first creative 305-1 in the predefined sequence of the first ad 301 to be loaded into the alternate content display buffer to be displayed within the first ad-spot 205-1. When the first ad spot 205-1 is over and the first creative 305-1 has been displayed, the micro-splicer instructs the display module of the display 114 to resume displaying the content and display the next segment of content 202-2 from the content display buffer thus completing the display of the first creative 305-1, stored in the alternate content display buffer. In embodiments this process is repeated for each subsequent ad spot until each creative in the predefined sequence is loaded into the alternate content display buffer to be displayed within an ad-spot. In embodiments, when each creative in an advertisement has been displayed in the predefined sequence the micro-splicer determines the next advertisement to be displayed a repeats the process for subsequently identified ad-spots and the creatives of the next advertisement.

In embodiments more than one creative may be displayed during a single ad-spot. The micro-splicer 115 will load the necessary number of creatives to be displayed into the alternate content display buffer for display during any ad-spot based on instructions in the metadata and the length of the ad-spot.

In embodiments, the micro-splicer 115 working with the processor 113 is configured to keep track of the completion of display of any creative that is uploaded into the alternate content display buffer for display. This allows the micro-splicer to manage the predefined sequence for the display of the creatives. In the embodiment shown in FIG. 6 the micro-splicer loads the correct creative in the predefined sequence of creatives 305-1, 305-2 and 305-3, of the first advertisement 301, into the alternate content display buffer for display in the consecutive ad-spots 205-1, 205-2 and 205-3 as the ad-spots are identified. Similarly the creatives of the second advertisement 311 are downloaded in the correct sequence by the micro-splicer into the alternate content display buffer so that they can be displayed in the required predefined sequence, such that creative 315-1 is displayed in the fourth ad spot 205-4 and creative 315-2 is displayed in the fifth ad spot 205-5. In embodiments, the instructions contained in the metadata in the ads instruct the micro-splicer 115 to repeat an ad and re-display the appropriate first creative of that ad in the next ad spot. An example of this embodiment is shown in FIG. 6 where the first creative 305-1 of ad 301 is redisplayed in the sixth ad spots 205-6.

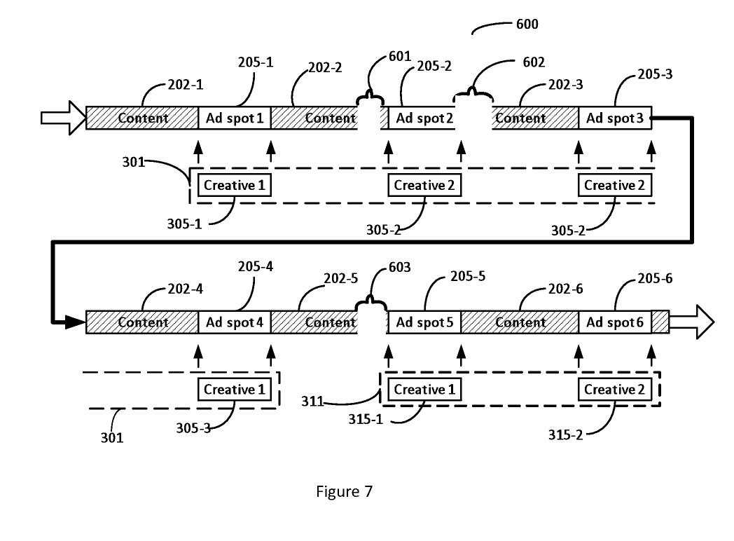

In embodiments the micro-splicer 115 together with the processor 113 on the ICDD are used to ensure that the display of a creative is completed before the next sequential creative is loaded and displayed. This is beneficial in the case of large ads with multiple creatives to be displayed in a predefined sequence as the message to be conveyed by the ad in its entirety is impacted if some creatives are displayed only partially due to the intermittent operation of the ICDD 110 by the user. This intermittent use may be caused for example by the user switching off the ICDD 110 before completion of the display of the creative. FIG. 7 shows an embodiment with an exemplary pattern 600 of displaying creatives 305-1, 305-2 and 305-3 in a predefined sequence of a first advertisement 301 and creatives 315-1 and 315-2 of a second advertisement 311 on an ICDD 110 where the user switches off the ICDD 110 intermittently at breaks 601, 602 and 603, while viewing content 125 on the ICDD 110. In the embodiment the ICDD is turned off during display of alternate content at a break 602 and the second creative 305-2 of the first advertisement 301 in not displayed completely. If the next creative, the third creative 305-3, of the first advertisement 301, in the sequence were displayed at the next ad spot 205-3, the impact to the user of the message of the first advertisement 301 would be diminished. In order to prevent this and for the user to receive the full impact of the message of the first advertisement 301 the second creative 305-2 displayed at ad spot 205-2 is identified by the micro-splicer as an incomplete display and the same creative, the second creative 305-2, is re-displayed at the next ad spot 205-3, with the remaining creatives of the advertisement being displayed in the predefined sequence from the next ad spot 205-4 on. In embodiments, for each subsequent creative that results in an incomplete display this process of redisplaying a creative in a next ad-spot is repeated until each creative in an advertisement is completely displayed in the predefined sequence of the creatives in the advertisement. This capability allows the message within the first advertisement 301 to have its full impact as all the creatives have been displayed completely to the user in the predefined sequence 365.

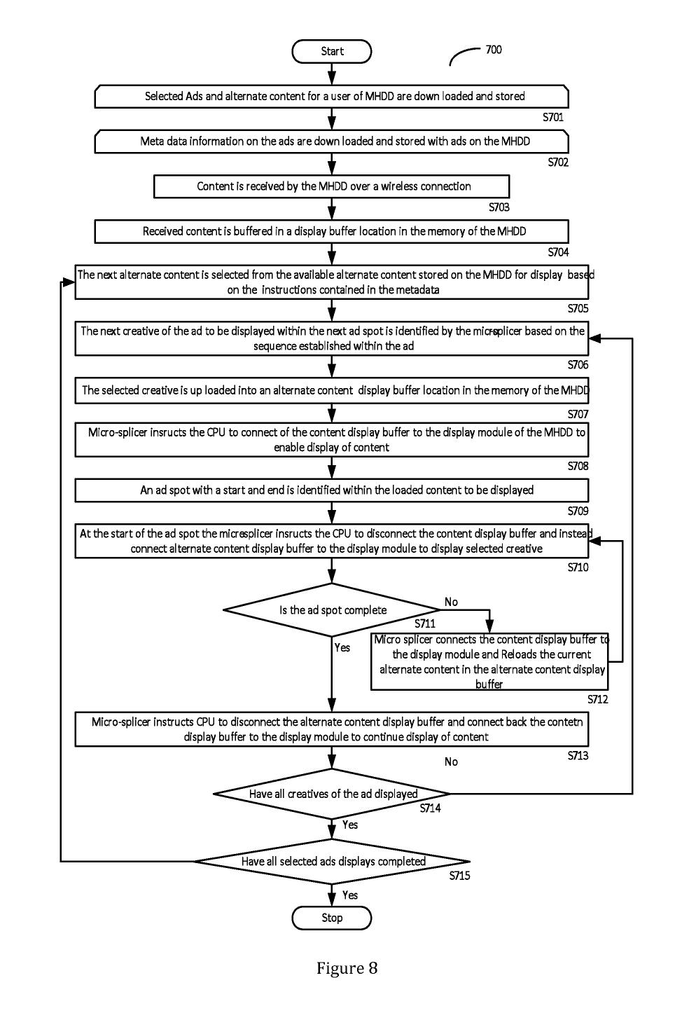

FIG. 8 is a flow chart of an embodiment of the display of large ads with multiple creatives providing complete message capability by eliminating partial display of creatives.

Selected advertisements and alternate content for an ad campaign developed by a client are selected for a user of a ICDD, in this embodiment shown as an MHDD, and the ICDD is enabled to download the advertisement and store it in an alternate content buffer on the ICDD (S701).

Metadata providing information on the advertisement and insertion instructions is downloaded and stored on the ICDD with the advertisement in the memory of the ICDD (S702).

Content stream is downloaded via wireless connection by the ICDD (S703).

Downloaded content is buffered in a display buffer location that is linked to a display module of the ICDD, in the memory of the ICDD (S704).

Once the content stream information has been received the micro-splicer on the ICDD in conjunction with a processor on the ICDD select the appropriate advertisement or alternate data to be displayed with the content based on the information contained in the metadata associated with the advertisement (S705).

The micro-splicer also identifies the predefined sequence of the creatives to be displayed and selects the next creative to be displayed with the content ready for display on the ICDD (S706).

The selected and identified creative is uploaded into an alternate content display buffer location within the memory of the ICDD (S707).

Micro-splicer instructs the processor to enable connection of the content display buffer to the display module for rendering and display of the contents of the content display buffer location on the display of the ICDD for the viewing by the user (S708).

When an ad spot within the content stream received is detected the start and end of the ad spot are identified and its characteristics, such as duration, are extracted and the information fed to the micro-splicer (S709).

At the start of display of the ad-spot the micro-splicer instructs the processor to disconnect the content display buffer from the display module and instead connect the alternate content display buffer to the display module to display selected creative that is currently within the alternate content display buffer (S710).

Since the ICDD can be switched off or used for some purpose other than content viewing, it is necessary to ensure completion of display of the selected alternate content, such as a creative, in the alternate content display buffer before the next creative is displayed. In order to ensure complete display of each creative, the end of the ad spot is monitored. The detection of the end of an ad spot indicates completion of display of the loaded creative. In the case where no end of ad spot is detected, this indicates that the ICDD has been diverted to some alternate use or switched off and the content of the alternate content display buffer has not been completely viewed (S711).

In the case where the content of the alternate content display buffer has not been viewed in full, micro-splicer instructs the processor to disconnect the alternate content display buffer from the display module and connect the content display buffer to the display module for current or future use. The micro-splicer also instructs the processor to re-load the alternate content display buffer with the current alternate content or creative that is the chosen creative if it has been corrupted, so that the creative can be displayed during the next ad spot available (S710). If the ICDD is switched off before the display of the creative is complete, the same creative is left in the alternate content display buffer for the next ad spot when the content viewing is re-started (S712).

In the case where the end of an ad spot is detected, the micro-splicer instructs the CPU to disconnect the alternate content display buffer from the display module and connect the content display buffer to the display module to continue viewing the content on the ICDD (S713).

The micro-splicer instructs the CPU to check the selected ad for additional creatives to be displayed in the predefined sequence. If any creatives in the predefined sequence have not been displayed the next creative in the sequence is loaded into the alternate content display buffer as shown at step (S706) for display during the next ad spot (S714).

If the creative displayed is the last creative in the predefined sequence of the advertisement, the microprocessor determines the next advertisement to be displayed based on the content being viewed based on the metadata and repeats the process from step (S705) to display the creative of that ad in the approved sequence (S715).

In embodiments the micro-splicer 115 on the ICDD 110 enhances the customer experience by identifying the most interesting creatives of the advertisements from the user preference information from past history available on the ICDD 110 or the user's interaction with the creatives of an advertisement, based on the user's response to a creative such as time spent on the creative or user interaction with the creative. This information can be further used to prioritize the display of creatives to the user for maximizing the impact of the message of the advertisements being displayed.

It will be evident to one of ordinary skill in the art that the techniques described herein above can be used to great advantage in providing significant capability to the process of displaying large advertisements with multiple creatives. It enables the organized display of large advertisements on an ICDD, where the creatives are displayed in a predefined sequence. The sequence of display of the creatives is defined by the client who develops the message of the advertisement. Further the method allows each creative in the sequence to be completed to allow the message to be completed and have the necessary impact defined by the client.

It will be readily appreciated by one of ordinary skill in the art that application of these techniques will produce more reliable, impact for the message of the advertisements. As will be understood by those familiar with the art, the invention may be embodied in other specific forms without departing from the spirit or essential characteristics thereof. Likewise, the particular naming and division of the members, features, attributes, and other aspects are not mandatory or significant, and the mechanisms that implement the invention or its features may have different names, divisions and/or formats. Further, the invention may be implemented as software executing on appropriate hardware, hardware, firmware, or any combination thereof for implementation on ICDD.

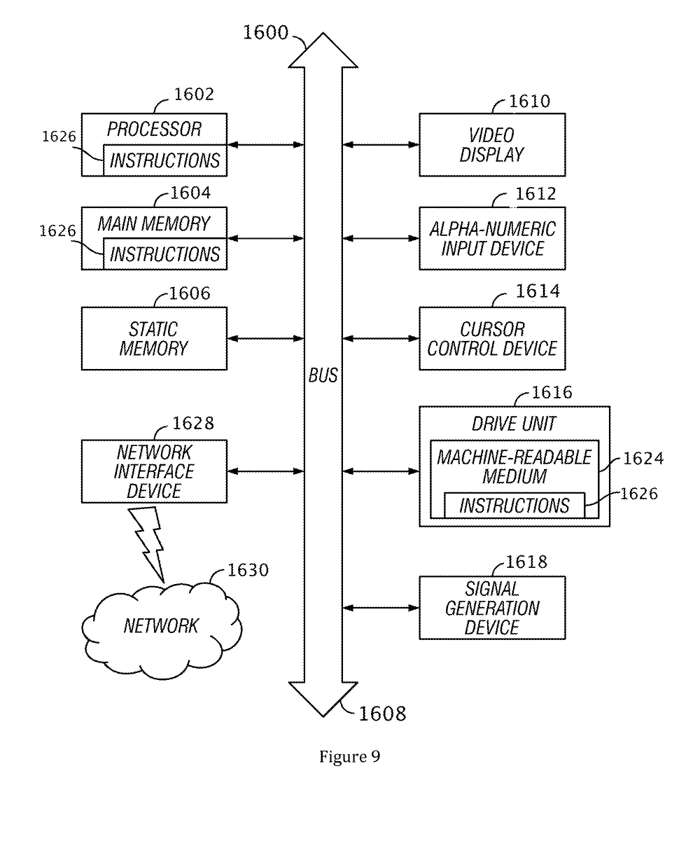

FIG. 9 is a block schematic diagram that depicts a machine in the exemplary form of a computer system 1600 within which a set of instructions for causing the machine to perform any of the herein disclosed methodologies may be executed. In alternative embodiments, the machine may comprise or include a network router, a network switch, a network bridge, personal digital assistant (PDA), a cellular telephone, a Web appliance or any machine capable of executing or transmitting a sequence of instructions that specify actions to be taken.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard; a cursor control device 1614, for example, a mouse; a disk drive unit 1616, a signal generation device 1618, for example, a speaker, and a network interface device 1628.

The disk drive unit 1616 includes a machine-readable medium 1624 on which is stored a set of executable instructions, i.e., software, 1626 embodying any one, or all, of the methodologies described herein below. The software 1626 is also shown to reside, completely or at least partially, within the main memory 1604 and/or within the processor 1602. The software 1626 may further be transmitted or received over a network 1630 by means of a network interface device 1628.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complementary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a machine or computer readable medium. A machine-readable medium includes any mechanism for storing or transmitting information in a form readable by a machine, e.g., a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the invention. Accordingly, the invention should only be limited by the Claims included below.

1. A computer implemented method for displaying an advertisement comprising multiple creatives to be displayed in a predefined sequence, comprising the steps of:
providing a display module;
providing an alternate content buffer to store alternate content;
providing a processor configured to store creatives associated with the advertisement in said alternate content buffer;
providing a micro-splicer;
said processor configured for displaying content on the display module;
selecting with said micro-splicer an advertisement comprising multiple creatives to be displayed in a predefined sequence;
said micro-splicer configured for displaying the creatives of the advertisement comprising the steps of;
said micro-splicer configured for detecting an ad spot within the content being displayed;
said micro-splicer configured for loading the first of the multiple creatives in the predefined sequence that has not been displayed into the alternate content buffer;
said micro-splicer configured for diverting with said micro-splicer an input of the display module from displaying content to displaying the creative stored in the alternate content buffer at the beginning of said detected ad spot; and
said micro-splicer configured for detecting the end of said ad spot and diverting with said micro-splicer the input of the display module from displaying a creative to displaying the content; and
determining with the micro-splicer if the advertisement contains additional creatives to be displayed in the predefined sequence and repeating the step of displaying the creatives of the advertisement until each of the creatives in the advertisement is displayed in the predefined sequence.

2. The method of claim 1, wherein determining with said micro-splicer an advertisement comprising multiple creatives to be displayed in a predefined sequence to be displayed comprises;
determining which of several advertisements to display based on the content being displayed and metadata associated with each advertisement;
wherein the metadata comprises instructions and information regarding the ad content, numbers of creatives in the advertisement and length of each creative.

3. The method of claim 1, wherein when the last creative in the predefined sequence of the advertisement is displayed the micro-splicer determines the next advertisement to be displayed and the step of displaying the creatives is repeated for the newly selected advertisement.

4. The method of claim 3, wherein the step of determining the next advertisement to be displayed comprises:
identifying the most interesting creatives of the advertisements from user preference information or user interaction with the creatives of an advertisement.

5. The method of claim 1,
wherein the step of loading the first of the multiple creatives in the predefined sequence that has not been displayed into the alternate content buffer further comprises loading at least one more creative following the first of the multiple creatives in the predefined sequence that has not been displayed; and
wherein multiple creatives are displayed during a single ad-spot.

6. The method of claim 1,
wherein when an end of an ad spot is not detected during the display of a creative the creative is not considered to have been displayed and the creative is reloaded into the alternate content buffer to be displayed during the next detected ad spot.

7. An apparatus for displaying an advertisement comprising multiple creatives to be displayed in a predefined sequence, comprising:
a display module for displaying content and alternate content;
an alternate content buffer configured to store creatives associated with the advertisement;
a micro-splicer;
wherein said micro-splicer is configured to select an advertisement comprising multiple creatives to be displayed in a predefined sequence;
wherein said micro-splicer is configured to display the creatives of the advertisement comprising the steps of;
said micro-splicer configured for detecting an ad spot within content being displayed;
said micro-splicer configured for loading the first of the multiple creatives in the predefined sequence that has not been displayed into the alternate content buffer;
said micro-splicer configured for diverting an input of the display module from displaying content to displaying the creative stored in the alternate content buffer at the beginning of said detected ad spot; and
said micro-splicer configured for detecting the end of said ad spot and diverting the input of the display module from displaying a creative to displaying the content; and
wherein said micro-splicer is configured to determine if the advertisement contains additional creatives to be displayed in the predefined sequence and configure to repeat the step of displaying the creatives of the advertisement until each of the creatives in the advertisement is displayed in the predefined sequence.

8. The apparatus of claim 7 wherein said micro-splicer is configured to determine which of several advertisements to display based on the content being displayed and metadata associated with each advertisement;
wherein the metadata comprises instructions and information regarding the ad content, numbers of creatives in the advertisement and length of each creative.

9. The apparatus of claim 7, wherein said micro-splicer is configured to determine and select the next advertisement to be displayed; and
wherein said micro-splicer is configured to display the creatives of the newly selected advertisement.

10. The apparatus of claim 9, wherein said micro-splicer is configured to identify the most interesting creatives of the advertisements from user preference information or user interaction with the creatives of an advertisement.

11. The apparatus of claim 7, wherein said micro-splicer is configured to load multiple sequential creatives in the predefined sequence into said alternate content buffer to be displayed during a single ad-spot.

12. The apparatus of claim 7, wherein said micro-splicer is configured to reload the previously displayed creative into the alternate content buffer if the end of the ad spot was not detected during the previous display of said previously displayed creative.
